(19) United States
(12) Patent Application Publication
(10) Pub. No.: US 2006/0138222 A1
(43) Pub. Date: Jun. 29, 2006

(54) Wireless auto insurance verification system

(76) Inventor: Dennis Michael Dearie, Greenwell Springs, LA (US)

Correspondence Address: Dennis M Dearie;Design Scan Inc, 15431 Red Maple Place, Greenwell Springs, LA, 70739, US

(21) Appl. No.: 09/661,361

(22) Filed: Aug. 20, 2001

(51) Int. Cl. G07B 15/02; G06F 17/00

(52) U.S. Cl. 235/384; 235/375

(57) ABSTRACT

A Windows based software application designed and written to be used in conjunction with wireless, portable, internet ready barcode/RF handheld scanners capable of checking the status of an automobiles' insurance coverage by reading a prefixed inspection sticker located on the inside of the windshield. States will have immediate knowledge if the policy is active or cancelled. States will be responsible to design their own unique sticker with barcode imprinted in a horizontal line with a minimum of ¼: clearance from either side. Insurance companies and inspection stations will work in conjunction to setup and maintain the integrity of information downloaded to DesignScan's server. Vehicles can be scanned without a driver inside the auto as the sticker will stand alone as to the validity of insurance coverage. Scanners will have two completely different, distinctive alarms to alert if there are any discrepancies in active coverage.

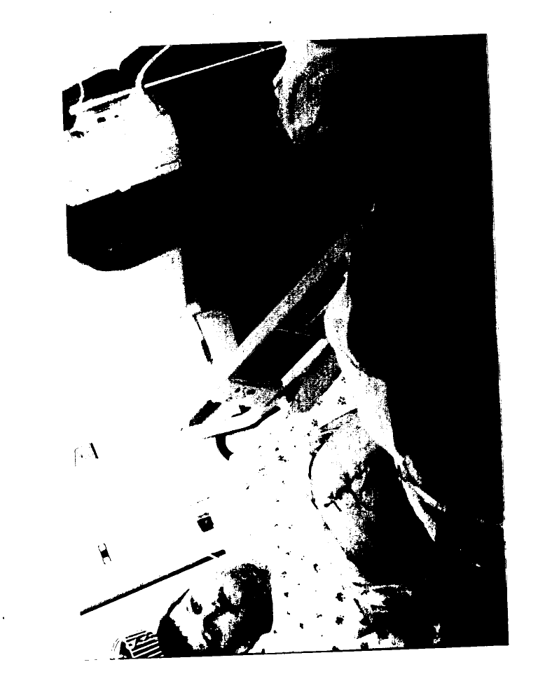

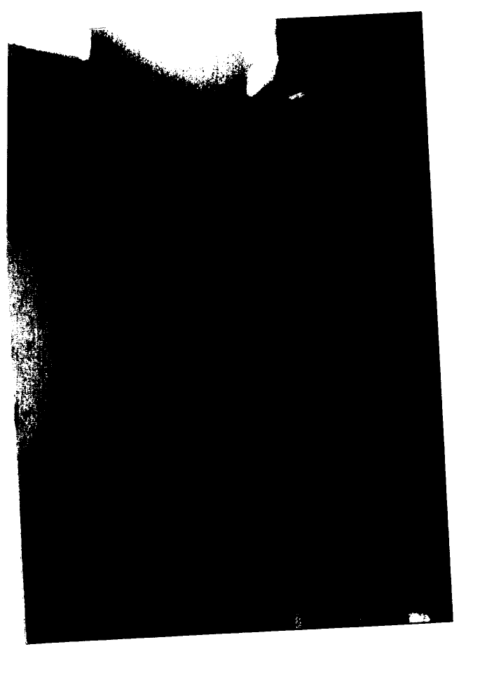

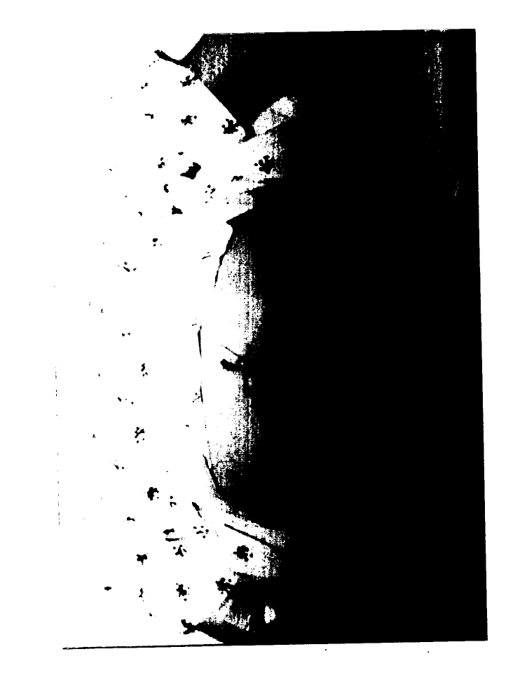

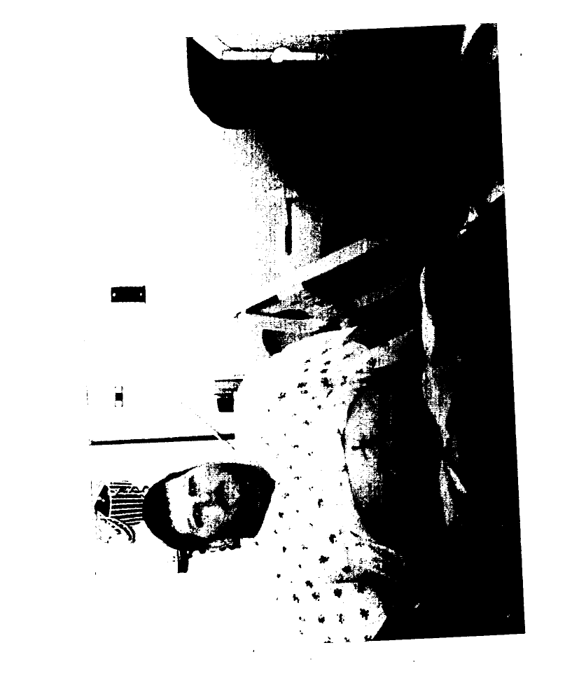

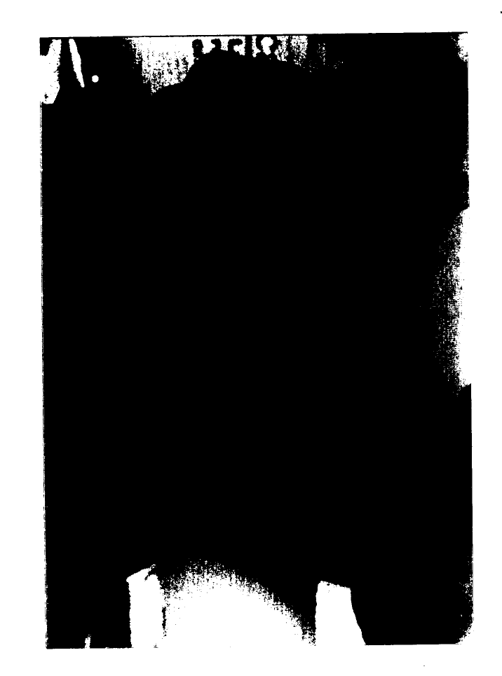

### BACKGROUND OF THE INVENTION

Businesses in today's world needed a way of being able to store information and the ability to retrieve it at the quickest and most accurate way available. The “birth” of barcoding inventory was the solution. Such uses were for inventory in stock at an individual sight, a specific warehouse or at job locations.

(1) Field of the Invention

Being able to track certain merchandise, the number of units for selected stock items and their locations were problems that businesses needed to have on hand at a moments notice. Speed also played a key role in the development of devices that viewed and de-coded the information. The birth of barcodes and barcode readers was the solution many businesses needed and adopted. Simply stated bar-coding is the use of a tag with several vertical lines, usually black in color and printed on a lightly contrasting colored background. The information is then retrieved by using a “reader” that uses a light source to scan the tag. It retrieves the information by criss-crossing over the tag, decodes the information and returns it to the operator. Bar-coding merchandise has become a standard in every aspect of modern businesses. They are used not only to track the number of items a business has but has evolved to bar-coding individual packages for immediately updating the location of an item or order and the status of delivery of that item. Bar-coding as a tool has enabled businesses to input information with the ability to retrieve that information with just the “click” of a button.

(2) Description of Related Art Including Information Disclosed Under 37 CFR 1.97 and 1.98:

N/A

### BRIEF SUMMARY OF THE INVENTION

Our “Insurance Verification System” is a combination of a Windows based software program we designed to be used with a portable, wireless, internet ready barcode reader to help law enforcement personnel and states to enforce mandatory auto insurance laws. Small inspection stickers with pre-printed barcodes are placed on the interior driver's side windshield which are scanned to confirm an insurance policy is in effect for that vehicle. Individual insurance companies use our system to update policies in “real-time”. There's no need waiting for the postal service to deliver notices on the status of an insurance policy. Updates such as renewals or cancellations can be uploaded immediately or at a scheduled time.

### BRIEF DESCIPTION OF THE SEVERAL VIEWS OF THE DRAWINGS

Depending on which manufacture/model number selected there are several hand held portable scanners. Other devices include a standard computer screen, keyboard and internet services.

### DETAILED DESCRIPTION OF THE INVENTION

A major problem Law Enforcement officials have is being able to insure compliance with mandated liability automobile insurance. Our “Insurance Verification System” or I.V.S. for short, gives Law Enforcement Officers that tool. Working together insurance companies, state approved inspection stations and law enforcement officials now have the ability to check the status of an auto's insurance coverage without interacting with drivers, the need to search for the proper papers, etc. Basics of the system is: Companies issuing automobile insurance policies and state certified inspection stations will be tied directly to DesignScan's server via standard internet connection. Each company and their individual employees will have their own unique “log in and password”. First time a vehicle is put into the system an application for a policy is made, issuing company “logs on” to our server then are prompted to enter the following information; policy number, effective dates, name, address and phone number of the register, Vehicle Identification Number (VIN), year, make, model and color of the vehicle. That information is then uploaded and can't be altered or changed except by the issuing company.

Second step is carried out by the inspection station. After “logging on” the operator inputs the V.I.N., and must verifying all information is correct. Only then can they proceed to the second set of instructions. Then using a pre-printed, state approved inspection sticker (barcode is already on sticker) the operator is prompted to enter date of inspection, mileage on vehicle, and license plate number. After successfully passing the inspection and filling out all fields the inspector uploads his portion of cycle onto DesignScan's server. Now the vehicle is on the I.V.S. system and can pass any scanning until either the policy changes or is cancelled. Vehicles with an active policy must pass a yearly inspection to continue on the system.

1. I is the sole designer of a Windows based software program titled: Insurance Verification System hereafter called I.V.S. I found a weekness in the enforcement of mandated liability auto insurance laws. In July 2000 I formed a company, DesignScan, Inc. to work on solving this loophole. With the advancement of computers and color printers many people were printing out fake insurance cards and presenting them as proof of coverage at insurance check-points. Our I.V.S. system is secure and is only assessable by having a unique “log in” and password. Insurance companies upload main information on the vehicle and registered owner. They then must pass inspection at a state certified inspection station. At that time all previous information is checked by issuing inspection station. They in turn affix a state approved barcode labeled inspection sticker on the inside lower left corner. The sticker is a “read only” style that contains all preloaded pertinent information. Upon going through the next insurance check point the sticker will be a “stand alone” for registration, inspection and active insurance policy being effective. Individual insurance companies use our system to update policies in “real-time”. There's no need waiting for the postal service to deliver notices on the status of an insurance policy. Updates such as renewals or cancellations can be uploaded immediately or at a scheduled time depending on which that company chooses.
